(19) United States
(12) Patent Application Publication
(10) Pub. No.: US 2024/0083769 A1
(43) Pub. Date: Mar. 14, 2024

(54) Method of Making Monodispersed Single Crystal Cathode Material

(71) Applicant: Redwood Materials, Carson City, NV (US)

(72) Inventors: Yu-Hua Kao, Sparks, NV (US); Fangfu Zhang, Reno, NV (US); Wesley Luc, Reno, NV (US); Edward Matios, Carson City, NV (US); Gurudayal Singhal, Reno, NV (US); Alan Nelson, Reno, NV (US)

(21) Appl. No.: 18/242,283

(22) Filed: Sep. 5, 2023

Related U.S. Application Data
(60) Provisional application No. 63/404,579, filed on Sep. 8, 2022.

(51) Int. Cl. C01G 53/00; H01M 10/0525

(52) U.S. Cl. CPC C01G 53/50; H01M 10/0525; C01P 2002/72; C01P 2004/52; C01P 2004/64; C01P 2006/40

(57) ABSTRACT

A method comprises: providing a metal salt solution including nickel, cobalt, manganese, aluminum, or a combination thereof; combining the metal salt solution with a basic solution wherein the combination of the metal salt solution and the basic solution is maintained at a pH of no greater than 10 to form a metal hydroxide precursor. To form cathode active material the method further includes adding a lithium compound to the metal hydroxide precursor to form a metal hydroxide precursor mixture; and heat-treating the metal hydroxide precursor mixture to form the single-crystal cathode active material.

### CROSS REFERENCE TO RELATED APPLICATION

This application claims priority to and the benefit of U.S. Provisional Patent Application No. 63/404,579, filed on Sep. 8, 2022, the contents of which is hereby incorporated by reference in its entirety.

### FIELD OF THE INVENTION

The field of this invention is a method of making single crystal cathode active material.

### BACKGROUND

Single crystal cathode active materials (CAM) for lithium ion batteries may have advantages over conventional layered oxide cathode active materials. For example, single crystal cathode active materials (sometimes called single crystal monolithic cathode active materials) can have one or more of high mechanical strength, structural stability, thermal stability, and long cycling life as compared to polycrystalline secondary agglomerate cathode active materials.

Previous attempts to manufacture single crystal CAM have included coprecipitation followed by multiple calcination or annealing steps. See e.g., WO2020/082019. Particle size control can be challenging. Thus, a coprecipitation method can sometimes involve milling of the initially calcined particles followed by one or more further annealing steps. See, e.g., WO2022/026014. Other methods include use of molten salts, sol-gel processing, and hydrothermal reactions.

A simplified process that provides monodisperse single crystal particles of desired particle size would be an advance in the technology.

### SUMMARY

Disclosed herein is a method of making a single-crystal cathode active material, the method comprising: providing a metal salt solution comprising nickel, cobalt, manganese, aluminum, or a combination thereof; combining the metal salt solution with a basic solution wherein the combination of the metal salt solution and the basic solution is maintained at a pH of no greater than 10 to form a metal hydroxide precursor; adding a lithium compound to the metal hydroxide precursor to form a metal hydroxide precursor mixture; and heat-treating the metal hydroxide precursor mixture to form the single crystal cathode active material.

Also disclosed herein is a method of making a monodispersed single crystal cathode active material, the method comprising: providing a metal hydroxide precursor comprising nickel, cobalt, manganese, aluminum, or a combination thereof, wherein the metal hydroxide precursor is characterized as semicrystalline and comprises a beta phase characterized by a peak at 17 to 23 degrees 2θ, when analyzed by X-ray diffraction using Cu K a radiation, and an intermediate phase characterized by having H₂O, ROH, RCOOH, an anion, or a combination thereof incorporated into a structure of the intermediate phase, wherein R is an alkyl group of 1 to 3 carbon atoms; adding a lithium compound to the metal hydroxide precursor to form a mixture; and heating the mixture in a one-step calcination to form the monodispersed single crystal cathode active material, the monodispersed single crystal cathode active material having a unimodal particle size distribution and a D50 particle size distribution of 100 nanometers (nm) to 5 micrometers (μm) or a D90 particle size distribution of 1 to 10 μm.

In addition, disclosed herein is a metal hydroxide composition comprising: a metal hydroxide comprising nickel, cobalt, manganese, aluminum, or a combination thereof, wherein the metal hydroxide is characterized as semicrystalline and comprises a beta phase characterized by a peak at 17 to 23 degrees 2θ, when analyzed by X-ray diffraction using Cu K a radiation, and having a formula M(OH)₂, wherein M is Ni, Co, Mn, Al, or a combination thereof, and an intermediate phase characterized by having H₂O, ROH, RCOOH, an anion, or a combination thereof incorporated into the structure of the intermediate phase, wherein R is an alkyl group of 1 to 3 carbon atoms.

Also disclosed is a single crystal cathode active material having the formula LiₓMO₂, wherein M is Ni, Co, Mn, Al, or a combination thereof, and 0<x≤1.2, and be characterized by a unimodal particle size distribution and a D50 particle size distribution of 100 nm to 5 μm, or a D90 particle size distribution of 1 to 10 μm, and the presence of Li₂SO₄.

### BRIEF DESCRIPTION OF THE DRAWINGS

Referring now to the figures, which are exemplary embodiments, and wherein the like elements are numbered alike.

FIG. 1 is a scanning electron micrograph (SEM) of coprecipitated particles according to Example 1.

FIG. 2 is a SEM of coprecipitated particles according to Example 2.

FIG. 3 is a SEM of coprecipitated particles according to Example 3.

FIG. 4 is a SEM of coprecipitated particles according to Example 4.

FIG. 5 is a SEM of coprecipitated particles according to Example 5.

FIG. 6A is a SEM of cathode active material particles according to Example 6.

FIG. 6B is a SEM of cathode active material particles according to Example 6.

FIG. 7 is a graph of intensity (arbitrary units) versus diffraction angle (degrees 2θ) showing the results of X-ray diffraction (XRD) analysis for the mixed metal hydroxides of Comparative Example 1 and Examples 1-4, when analyzed using Cu Kα radiation.

FIG. 8 is a graph of intensity (arbitrary units) versus diffraction angle (degrees 2θ) showing X-ray diffraction (XRD) analysis for the mixed metal hydroxides of Example 5, when analyzed using Cu Kα radiation.

FIG. 9 is a graph of intensity (arbitrary units) versus diffraction angle (degrees 2θ) showing the results of X-ray diffraction analysis for the cathode active material of Example 6, when analyzed using Cu Kα radiation.

FIG. 10 is a graph of intensity (arbitrary units) versus diffraction angle (degrees 2θ) showing X-ray diffraction analysis for the cathode active material of Example 7, when analyzed using Cu Kα radiation.

FIG. 11 is a graph of distribution density versus particle size (micrometers, μm) showing particle size distribution for cathode active material particles as synthesized in Example 6.

FIG. 12 is a graph of distribution density versus particle size (micrometers, μm) showing particle size distribution for cathode active material particles as synthesized in Comparative Example 2.

FIG. 13 is a graph of intensity (arbitrary units) versus diffraction angle (degrees 2θ) showing the results of X-ray diffraction analysis for the cathode active material of Comparative Example 2, when analyzed using Cu Kα radiation.

### DETAILED DESCRIPTION

The methods as disclosed herein provide efficient means of manufacture of monodisperse single-crystal cathode active materials without the need for multiple calcination or annealing steps, milling, complex chemistries, or high energy processes often associated with sol-gel, molten salt, or hydrothermal methods.

Particularly, it was found that careful control of the pH during a coprecipitation of a metal sulfate solution can lead to a unique metal hydroxide precursor. This unique metal hydroxide precursor in turn was found to be able to be mixed with lithium compounds and readily calcined into monodisperse single crystal cathode active material particles having a small particle size. The calcining can occur in a single step, although additional steps are not excluded.

### Metal Hydroxide

A metal hydroxide precursor formed by or used in the method as disclosed herein can be characterized as including a beta phase and an intermediate phase. The beta phase can be characterized by X-ray diffraction (XRD) as displaying a peak in the range of 17 to 23 degrees 2θ, when analyzed using Cu Kα radiation. The beta phase can be crystalline, amorphous, or comprise a combination of crystalline and amorphous particles. The beta phase can have the formula M(OH)₂, where M is a metal. For example, the metal M can be nickel, cobalt, manganese, aluminum, or a combination thereof. As another example, the metal can comprise nickel, cobalt, and manganese in a nickel:cobalt:manganese mole ratio of greater than 0 to 1 mole nickel:greater than 0 to 1 mole cobalt:greater than 0 to 1 mole manganese; or preferably 1 mole nickel:0.1 to 0.2 moles cobalt:0.1 to 0.2 moles manganese. For example, the mole ratio of nickel:cobalt:manganese can be 1:0.125:0.125, or 1:0.18:0.18.

The X-ray diffraction patterns can also or alternatively show an alpha phase in some instances. The alpha phase is characterized by a peak in the range of 5 to 15 degrees 2θ, when analyzed by X-ray diffraction using Cu K_{α} radiation. The X-ray diffraction can be measured using a commercially available X-ray diffractometer, such as, for example, a Rigaku™ Miniflex.

The intermediate phase can be characterized by a peak or upward slope in an XRD pattern in the range of 15 to 17 degrees 2θ, when analyzed by X-ray diffraction using Cu K_{α} radiation, or by the presence of water, a solvent or an anion included in the structure of the intermediate phase. The intermediate phase can have the formula M(OH)₂·yZ, where 0<y<0.75 and Z represents H₂O, a solvent, an anion, or a combination thereof. For example, as a solvent, Z can be ROH or RCOOH wherein R is an alkyl group of 1 to 3 carbon atoms. As an anion, Z can be, for example, OH⁻, SO₄²⁻, NO₃⁻, CO₃²⁻, F⁻, Cl⁻, or a combination thereof. Z preferably can be water or a sulfate ion, and, more preferably, is water. The Z element is incorporated into the structure of the intermediate phase. In an aspect, 0<y<0.75, 0.1<y<0.65, or 0.2<y<0.55.

The metal hydroxide precursor can comprise residual sulfur in an amount of at least 0.1 weight percent (wt %) to less than 3 wt % residual S content, preferably less than 2.5 wt %, more preferably less than 2 wt %, each based on the total weight of the metal hydroxide precursor.

In an aspect, the metal hydroxide precursor has a tap density of 0.1 grams per cubic centimeter (g/cc) to 1.5 g/cc, preferably 0.1 to 1 g/cc, more preferably 0.1 to 0.5 g/cc. The tap density may be determined according to ASTM B527, the content of which is incorporated herein by reference in its entirety.

### Method of Making Metal Hydroxide

To make the metal hydroxide precursor, a metal salt solution can be provided. Combining the metal salt solution with a basic solution can cause precipitation of the metal hydroxide precursor. The metal salt solution comprises a metal salt of nickel, cobalt, manganese, aluminum, or a combination thereof.

For example, the metal salt solution can be a metal sulfate solution, a metal hydroxide solution, or a metal nitrate solution. The metal salt solution can include one metal or a mixture of two or more metals. In solution, the metal(s) will be present in ionic form. In an aspect, the metal salt solution is an aqueous solution of a sulfate. The sulfate may comprise nickel sulfate, manganese sulfate, cobalt sulfate, aluminum sulfate, or a combination thereof. Use of NiSO₄·6H₂O—, MnSO₄·H₂O, and CoSO₄·7H₂O is mentioned.

The concentration of the metal salt in the metal salt solution can be, for example, 0.2 to 2.2 moles metal salt per kilogram of solvent (molal), or 0.2 to 3 moles metal salt per liter of solution (molar). The solvent in the metal salt solution can comprise water. The metal salt solution can comprise a metal obtained from a recycled feedstock, preferably a post-industrial recycled feedstock, a post-consumer recycled feedstock, or a combination thereof. In an aspect, the nickel, cobalt, manganese, aluminum, or combination thereof of the metal salt solution is obtained from a recycled feedstock.

The basic solution can comprise an alkali metal hydroxide, ammonium hydroxide, or a combination thereof. Any suitable alkali metal hydroxide may be used. The alkali metal may be Li, Na, K, Rb, Cs, Fr, or combination thereof. For example, the alkali metal hydroxide and ammonium hydroxide can be present in a mole ratio of 2:1 to 1:2, or 1.5:1 to 1:1.5, or 1.2:1 to 1:1. If the basic solution comprises a combination, separate solutions may be added to the metal salt solution, or the basic solutions can be pre-combined and then combined with the metal salt solution. The concentration of ammonia can be 0.2 to 20 molar, or 0.2 to 19 molal. The concentration of alkali hydroxide can be 0.2 to 20 molal or 0.2 to 30 molar.

The basic solution(s) and metal salt solution can be combined in a batch manner. Alternatively, one of the metal salt and basic solutions can be provided in a vessel and the other solution added as a continuous feed. As yet another example, both the basic solution(s) and the metal salt solution(s) can be continuously added to the vessel.

The pH of the combination of the metal salt solution and the basic solution is no greater than 10, preferably less than 10. At a greater pH, no alpha phase or intermediate phase is observed by X-ray diffraction. At a pH of 7 to 8, the alpha phase is observed and the intermediate and beta phases may not be observed. At a pH of at least 8 up to 10, a useful combination of beta and intermediate phases are observed. Accordingly, the pH of the combination of the metal salt solution and the basic solution can be at least 8, or at least 8.5 or at least 9, or at least 9.5, or at most 10, or at most 9.5, or at most 9, or at most 8.5.

The combination can be heat-treated at a temperature in the range of 25 to 60° C. The combination can be agitated, for example in a continuously stirred tank reactor. The agitation rate can be in the range of 200 to 1000 RPM. The metal hydroxide formed in the combined solution can have a solid loading of 2 to 20 wt %, preferably 5 to 15 wt %, more preferably 8 to 15 wt %, based on a total weight of the combined solution. The precipitate of the metal hydroxide can be collected by any suitable solid-liquid separation technique, for example by filtration, centrifugation, decantation, or other suitable solid/liquid separation processes, or a combination thereof. The isolated precipitate can be washed. The washing can reduce the filtrate conductivity to a desired level, for example to less than 400 microSiemens/centimeter (μS/cm), or less than 350 μS/cm.

### Method of Making Monodisperse Single Crystal Cathode Active Materials

The metal hydroxide as discussed above can be used to form a cathode active material. Particularly, a lithium compound can be added to the metal hydroxide to form a mixture, which is then heated to form the cathode active material.

Surprisingly, it was found that when the metal hydroxide includes the beta and intermediate phases, small unimodal, monodispersed single crystal cathode active materials can be formed in a single heating step. Without wishing to be bound by theory, it is possible that the beta phase acts as nuclei and the intermediate phases function as a particle growth reagent that promotes particle growth during heating (e.g., calcination).

The lithium compound can comprise lithium hydroxide, lithium carbonate, lithium oxide, lithium oxalate, or a combination thereof. A mole ratio of the lithium compound to the metal hydroxide compound can be 1 to 1.2, preferably 1.02 to 1.15, or more preferably 1.05 to 1.10.

The heating step can comprise calcining or sintering, and can comprise heating at a temperature of 600 to 1100° C., preferably 800 to 1000° C., and more preferably 850 to 950° C. The heating can occur, for example, for 2 to 24 hours. While a single heating step has been found to form small unimodal, monodisperse single crystal cathode active material, additional heating steps can be used. In some instances, the mixture subjected to heating can comprise 0.1 to 4 wt % lithium carbonate, based on a total weight of the mixture. In some aspects, additional heating steps are excluded from the present method.

The method can further include washing the cathode active material after the heating. The washing may comprise washing with any suitable liquid, e.g., water, or an aqueous solution of water with a C₁₋₄ alcohol (e.g., methanol, ethanol, isopropanol, butanol). Washing with water is mentioned.

### Monodispersed Single Crystal Cathode Active Material

The monodispersed single crystal cathode active material formed by the method described above can have the formula LiₓMO₂, wherein M is Ni, Co, Mn, Al, or a combination thereof, and 0<x≤1.2. For example, the single crystal cathode active material can have a formula of LiₓNi_{y}Co_{z}MnᵥO₂, wherein 0<x≤1.2 and 0.8≤(y+z+v)≤1.1. In an example, y can be 0.1 to 1, z can be 0.01 to 0.1, and v can be 0.01 to 0.1, preferably y can be 0.5 to 1, z can be 0.02 to 0.1, and v can be 0.02 to 0.1. As a specific example, y can be 0.7 to 1, z can be 0.02 to 0.1, and v can be 0.02 to 0.1. In an aspect, the single crystal cathode active material can have the formula LiNi_{0.88}Co_{0.06}Mn_{0.06}O₂.

The single crystal cathode active material can have a unimodal particle size distribution, be monodisperse, and have a small particle size. For example, the D50 particle size can be at least 100 nanometers (nm) to less than 20 micrometers (μm). Within this range, the D50 particle size can be 500 nm to 10 μm, or 1 to 5 μm, or 1 to 3 μm. The D90 particle size can be 1 to 20 μm. Within this range, the D90 particle size can be 3 to 20 μm, or 5 to 8 μm. Particle size and distribution can be determined using a particle size analyzer e.g., HELOS-RODOS model H3365. Particle size can be determined using a wet method. D50 particle size denotes the median diameter, i.e., the particle size at 50% in cumulative distribution. D90 particle size denotes the particle size at 90% cumulative distribution meaning that 90% or the particles are smaller than this size. The D50 particle size, D90 particle size, and particle size distribution can be determined according to ASTM C115, the content of which is incorporated herein by reference in its entirety.

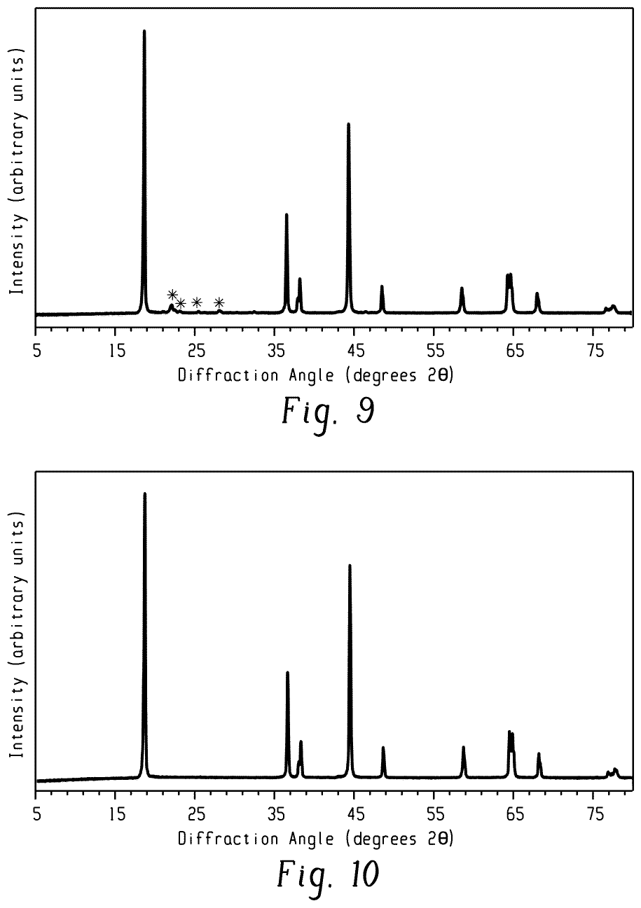

The single crystal active material made according to the method disclosed herein using a sulfate salt can have residual Li₂SO₄. The presence of the sulfate salt may be determined by X-ray diffraction peaks at 22 to 29 degrees 2θ, when analyzed using Cu K_{α} radiation, as seen in FIG. 9.

The cathode active material comprises less than 10 wt %, or less than 7 wt %, based on total weight of cathode active material, of residual lithium hydroxide, lithium carbonate, lithium oxide, lithium oxalate, lithium sulfate, or a combination thereof, on the surface of the cathode active material. For example, the cathode active material may comprise 0 to 10 wt %, or 0 to 7 wt %, or 0 to 5 wt %, or 0 to 3 wt %, or greater than 0 to 10 wt %, or greater than 0 to 7 wt %, or greater than 0 to 5 wt %, or greater than 0 to 3 wt % of of residual lithium hydroxide, lithium carbonate, lithium oxide, lithium oxalate, lithium sulfate, or a combination thereof, on the surface of the cathode active material, each based on total weight of cathode active material.

In an aspect, the cathode active material is characterized by an average discharge capacity of greater than 200 milliampere-hours per gram (mAh/g) at a discharge rate of C/3 for a half-cell over 100 cycles. The half-cell may use a lithium metal anode. A C/3 rate means a current which will discharge a battery in 3 hours, and can be determined using a cathode active material specific capacity of 230 mAh/g.

### Method of Forming Electrode and Cell

The cathode active material disclosed herein can be used to form a cathode by combining the cathode active material with a conductive material, such as carbon black, and a binder material, such as a suitable polymeric material (e.g., polyvinylidene fluoride, a cellulosic polymer, or the like), and applying the combination to a current collector. The combination can be in the form of a slurry with a carrier solvent, such as N-methyl pyrrolidone (NMP). The electrode can be used in an energy storage device.

### EXAMPLES

### Test Methods:

Particle size distribution (PSD) was characterized in the examples using a HELOS & RODOS model H3365 (Software PAQXOS 5.1.1) particle size analyzer. For analysis, less than 100 milligrams (mg) of powder was dispersed in 20 milliliters (mL) of water with 1 minute sonication prior to analysis. Standard measuring range (e.g., R3 and R5: 0.5 to 875 μm) was used for the measurement. A Rigaku™ Miniflex was used in the examples for X-ray diffraction (XRD) analysis. A Cu radiation source with voltage of 40 kV and 15 mA is used. The wavelength for Ka1 and Ka2 is 1.54059 Å and 1.54441 Å, respectively. Scan condition: 1D scan (θ/2θ, D/tex Ultra detector) with step width of 0.01° and a scan rate of 10°/min. The scan range was 5 to 80 degrees 2θ.

Scanning electron micrographs were collected using a Phenon™ XL microscope. The accelerating voltage was 15 kV with 20,000-25,000× magnification. Backscattering mode was used for all images.

Residual Li quantification was characterized by Metrohm™ auto-titration to measure residual lithium content in the cathode active materials. A HCl (0.1 normal (N)) standard was used for titration, and two titration end points were detected. The two end-point pH values are corresponding to 8.1 and 4.4, respectively. Lithium hydroxide and lithium carbonate content (wt %) can be determined by the HCl volume needed to reach the first and second titration end points.

Electrode Preparation: Cathode active material (CAM) powder was mixed with conductive carbon black and PVDF binder at a ratio of 94:3:3 by weight. Together with N-methyl-2-pyrrolidone (NMP) to adjust the slurry rheology, the mixture was mixed with a THINKY MIXER™ planetary mixer. Mixing conditions: repeat 2000 RPM for 1 minute mixing for ten times with 1 minute rest period in between. The slurry was then cast on Al foil using 254 mm doctor blade followed by drying at 60° C. to remove a majority of the NMP solvent, and then dried at 120° C. for 5 minutes. The cast film was then further dried at 110° C. overnight for at least 12 hours under vacuum to ensure proper drying and PVDF curing. A coin half cell (CR2032) with a Li metal anode is assembled using an electrolyte comprising 1.2 M LiPF₆ in ethylene carbonate (EC):ethylmethyl carbonate (EMC) (3:7 v/v %)+2 wt % vinylene carbonate (VC), and tested using an Arbin tester.

Electrochemical testing protocol: The coin half-cell was firstly charged using constant current/constant voltage (CC-CV) protocol with C/10 constant charge current until a cutoff voltage of 4.3V, followed by constant voltage charging until the charging current drops to C/20. Then the cell was discharged at different C rates with a discharge cutoff voltage of 2.8V. Charge and discharge rates were determined based on the weight of the cathode active material and assuming a specific capacity of 230 mAh/g.

### Comparative Example 1

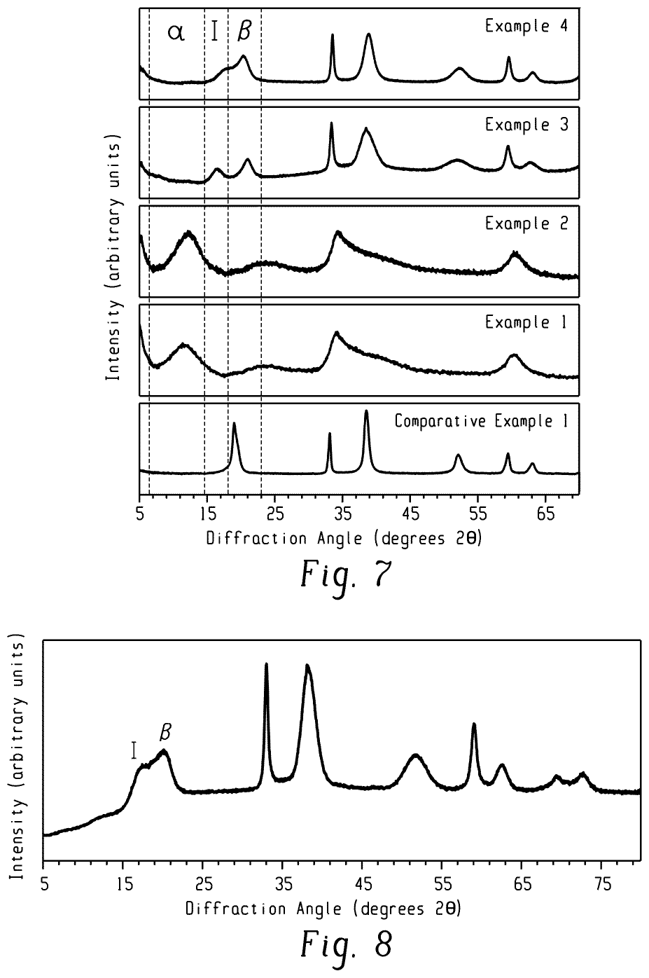

A metal sulfate solution (MSO₄) of NiSO₄·6H₂O, MnSO₄·H₂O, and CoSO₄·7H₂O in water and having a total concentration of 2 moles per liter (M) with a stoichiometric ratio of Ni:Mn:Co of 8:1:1 was prepared. Separate feeds of an aqueous ammonium hydroxide (NH₄OH) solution (5 M) and a NaOH solution (2 M) were used as chelant and precipitant, respectively. A 3 liter (L) continuously stirred tank reactor (CSTR) was charged with a 0.75 M NH₄OH solution, followed by coaddition of the metal sulfate solution (MSO₄), NH₄OH, and NaOH. The flow rate for the MSO₄ and the NH₄OH feeds were maintained at 0.108 liters/hour (L/h) and 0.083 L/h, respectively, so that the mole ratio of NH₃:M was kept constant at 1.92. The NaOH addition rate was also kept constant at 0.108 L/h to facilitate continuous precipitation. The system reached a steady state after 48-50 hours, at which point all reagent concentrations were constant. The reactor temperature was maintained at 50° C. with a stirring rate of 1085 rotations per minute (RPM). By adjusting the metal and NH₄OH feed, the solution pH was kept constant at 11.3. Continuous purging of N₂ to the solution as well as blanketing the solution with N₂ was performed to prevent transition metal oxidation. An X-Ray diffraction (XRD) pattern of the product is shown in FIG. 7.

### Example 1

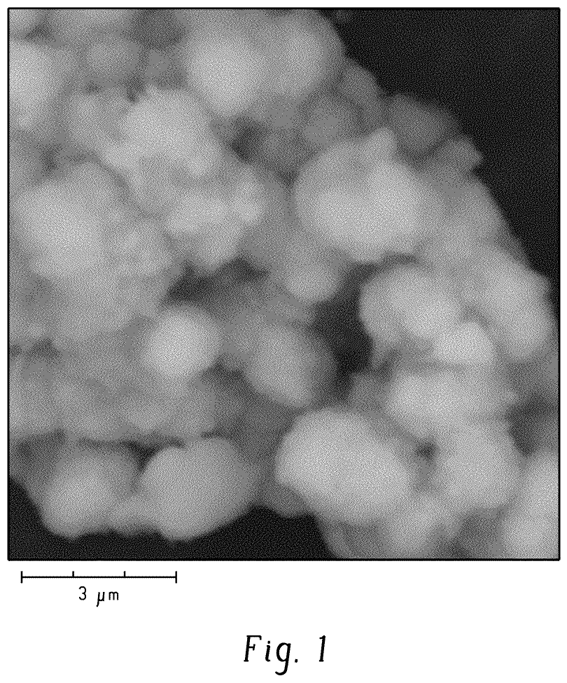

A 0.6 m (molal, i.e., moles of solutes (e.g., mixed metal sulfate)/kilogram of solvent) mixed metal sulfate solution (Ni/Co=90/10), and a basic solution (i.e., 0.6 m of aqueous (aq) NH₄OH with deionized (DI) water were prepared. The mixed metal solution and basic solution were preheated to 40° C. Equal amounts of the mixed metal and the basic solution (i.e., 100 milliliters (mL) each) were premixed in a 1 liter (L) reaction vessel and maintained at 40° C. The mixed metal solution and the basic solution were coadded to the reactor at a rate of 1 mL/minute and mixing was continued for 5 hours. The pH of the solution was 7.01. Solid loading in the slurry was 1.1 wt %. The precipitate was then separated by filtration, and washed with DI water until the filtrate conductivity was less than 350 microSiemens/centimeter (mS/cm). An SEM of the resulting mixed metal hydroxide is shown in FIG. 1. The XRD pattern of the product is shown in FIG. 7.

### Example 2

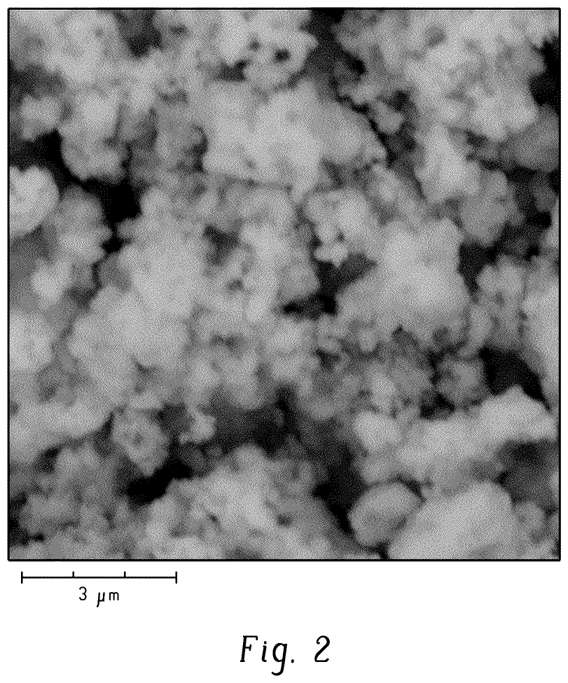

A 0.6 m mixed metal sulfate solution (Ni/Co=90/10), and a basic solution (i.e., 0.6 m NH₄OH (aq) and 0.2 m NaOH solution) were prepared with DI water. The mixed metal solution and the basic solution were preheated to 40° C. Equal amounts of mixed metal solution and the basic solution (i.e., 100 mL each) were premixed in a 1 L reaction vessel and maintained at 40° C. The mixed metal solution and the basic solution were coadded to the reactor at a rate of 1 mL/min and mixing continued for 5 hours. The pH of the solution was 7.41. Solid loading in the slurry was 1.6 wt %. The precipitate was then isolated by filtration, and washed with DI water until the filtrate conductivity was less than 350 μS/cm. An SEM of the product is shown in FIG. 2. XRD of the product is shown in FIG. 7.

### Example 3

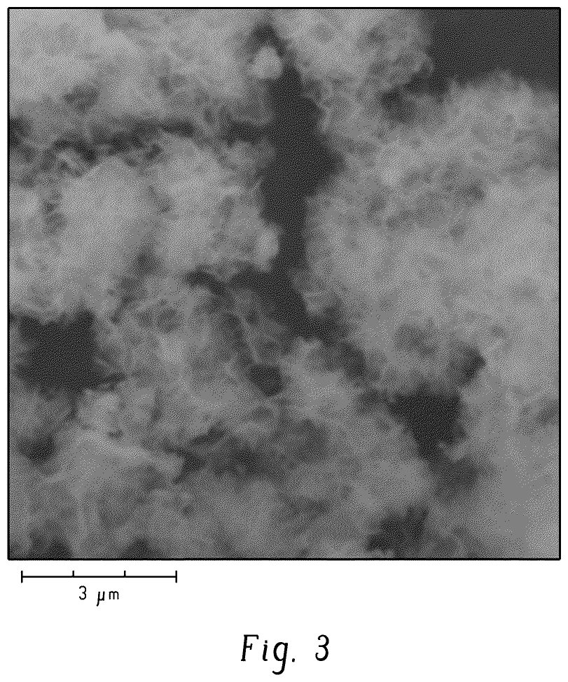

A 0.9 m mixed metal sulfate solution (Ni/Co=90/10), and two separate basic solutions (i.e., 0.9 m NH₄OH (aq) and 0.96 m NaOH solution) were prepared with DI water. The mixed metal solution and both basic solutions were preheated to 40° C. Equal amounts of the mixed metal solution and the basic solutions (i.e., 70 mL each) were mixed in a 1 L reaction vessel and maintained at 40° C. All solutions, i.e., the mixed metal solution and the two basic solutions, were coadded to the reactor at a rate of 0.7 mL/min and mixed for 5 hours. The pH of the solution was 8.55. Solid loading in the slurry was 2.5 wt %. The precipitate was then isolated by filtration, and washed with DI water until the filtrate conductivity was less than 350 μS/cm. An SEM of the product is shown in FIG. 3. XRD of the product is shown in FIG. 7.

### Example 4

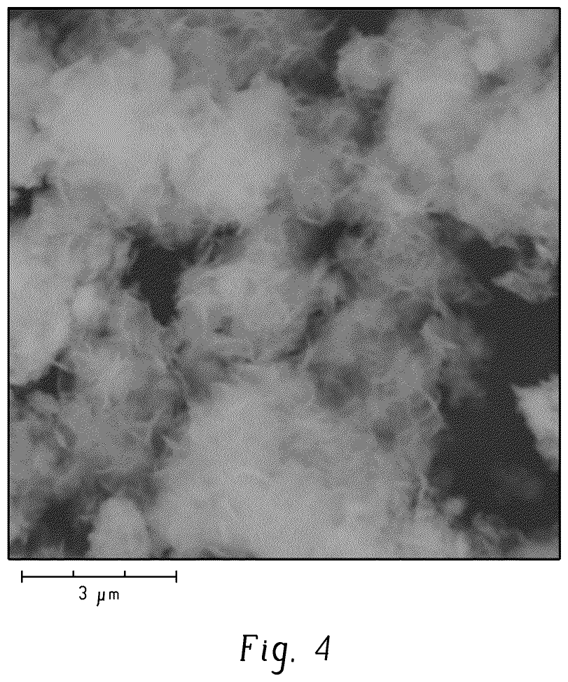

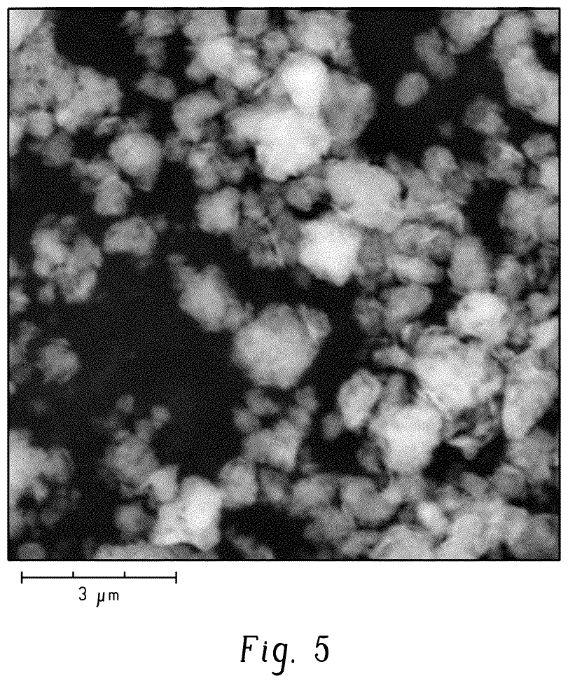

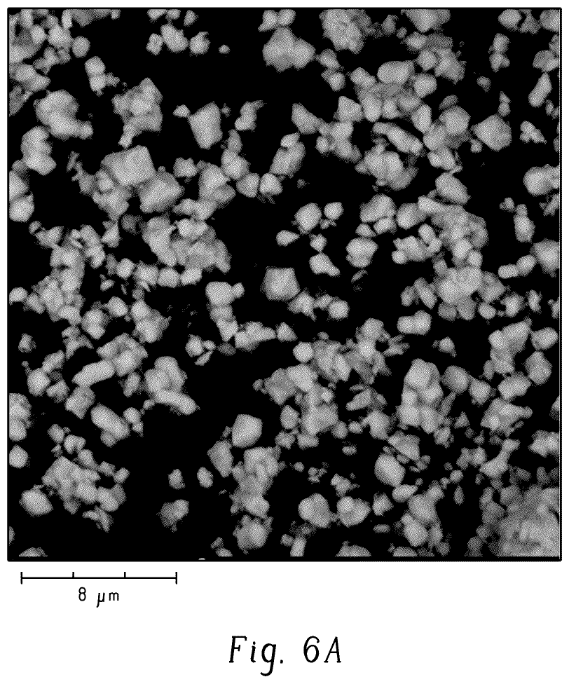

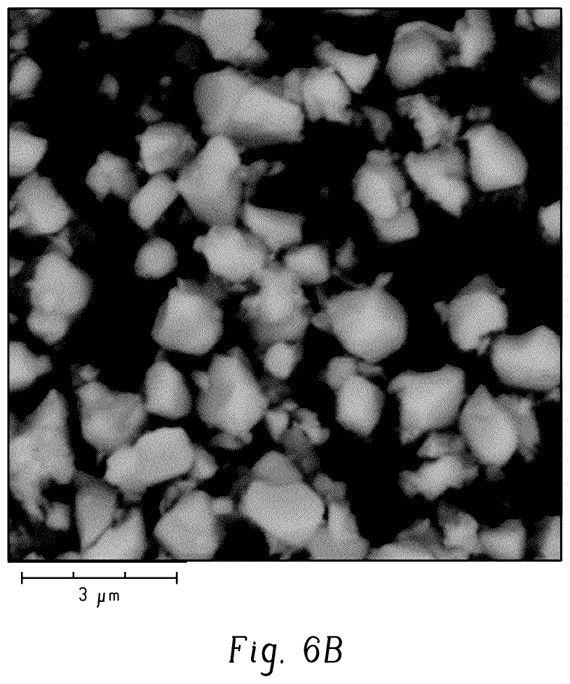

A 0.9 m mixed metal sulfate solution (Ni/Co=90/10), and two separate basic solutions (i.e., a 0.9 m NH₄OH (aq) and a 1.29 m NaOH solution) were prepared with DI water. The mixed metal sulfate solution and both basic solutions were preheated to 40° C. Equal amounts of mixed metal sulfate solution and the basic solutions (i.e., 70 mL each) were premixed in a 1 L reaction vessel and the temperature maintained at 40° C. The mixed metal sulfate solution and the two basic solutions were coadded to the reactor at a rate of 0.7 mL/min and then mixed for 5 hours. The pH of the solution was 9.54. Solid loading in the slurry was 2.6 wt %, based on a total weight of the slurry. The precipitate was then isolated by filtration, and washed with DI water until the filtrate conductivity was less than 350 μS/cm. An SEM of the product is shown in FIG. 4. XRD of the product is shown in FIG. 7.

### Example 5

A 2.1 m mixed metal sulfate solution (Ni/Co/Mn=1.89 m/0.105 m/0.105 m), and two separate basic solutions (i.e., a 15 m NH₄OH (aq) and a 8.33 m NaOH solution) were prepared with DI water. When preparing the mixed metal sulfate solution and the NaOH solution, N₂ purge was utilized continuously to displace any dissolved oxygen in solution to avoid Mn oxidation in the following co-precipitation. For the NH₄OH (aq) solution, the proper amount of water was purged with N₂ and then the N₂ purge was stopped, followed by the addition of the desired amount of concentrated NH₄OH (aq). The mixed metal solution and both basic solutions were preheated to 40° C. Then the mixed metal and basic solutions were premixed in a 1 L reaction vessel at a ratio of 14:2:5 (e.g., 140, 20, and 50 mL for the mixed metal, NH₄OH (aq), and NaOH, respectively) and maintained at 40° C. The mixed metal sulfate solution and the two basic solutions were coadded to the reactor at a rate of 1.4, 0.2, and 0.5 mL, respectively and mixed for 5 hours. Continuous purging of N₂ to the solution as well as blanketing of the solution with N₂ was performed to prevent transition metal oxidation.

The pH of the solution was 8.92. Solid loading in the slurry was 8.9 wt %, based on a total weight of the slurry. The precipitate was then isolated by filtration, and washed with DI water until the filtrate conductivity was less than 350 pS/cm.

An SEM of the product is shown in FIG. 4. XRD of the product is shown in FIG. 8.

### Example 6

The product of Example 5 was mixed with 15 μm lithium hydroxide monohydrate at a mole ratio of Li/Me=1.08, wherein Me is the combination of the metals Ni, Co, and Mn, followed by high temperature calcination at 900° C. for 10 hours under oxygen atmosphere. FIG. 9 shows the XRD pattern, and indicates that the product has a highly ordered R3̅m layered cathode active material (CAM) with low Li/Ni cation disorder of 2.17 mole percent and trace amounts of lithium sulfate. The results of particle size distribution analysis are shown in FIG. 11. The product had a D50 of 2.01 micrometers (μm), and D90 of 5.03 μm.

### Example 7

The product of Example 6 was further subjected to washing to remove residual Li compounds. Three grams (g) of the CAM of Example 6 was rinsed with 60 g of cold DI water (T<10° C.) for 10 mins. The CAM was filtered and rinsed with another 60 g of cold DI water. The rinse water was analyzed for residual Li by titration. The residual LiOH and Li₂CO₃ was 0.09 wt % and 0.04 wt %, respectively, based on a total weight of the CAM before washing. The wet cake was further dried and analyzed by XRD to ensure structural integrity. As shown in FIG. 10, an XRD pattern after the washing procedure was the substantially same as for Example 6, but without the small peaks associated with the trace amounts of lithium sulfate.

### Comparative Example 2

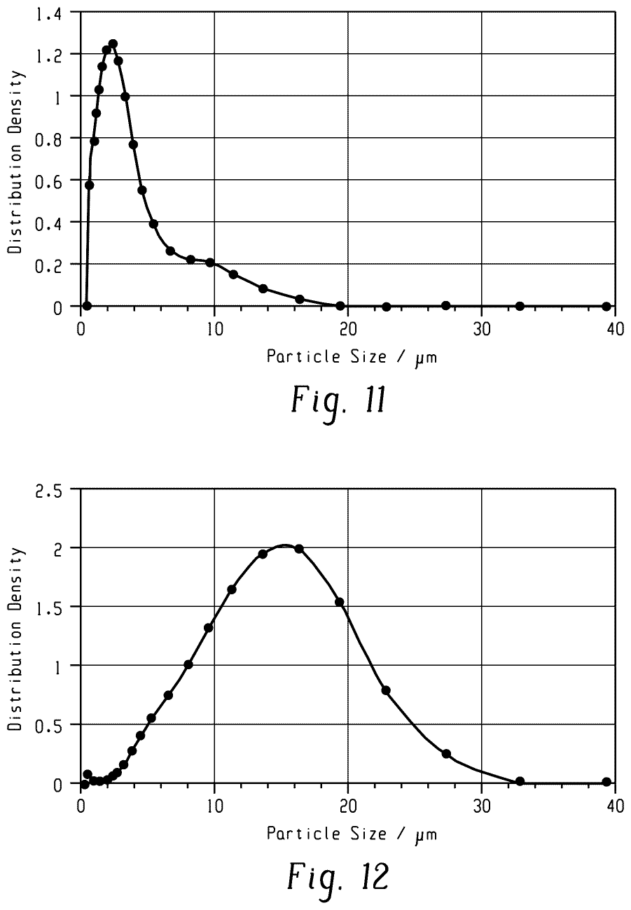

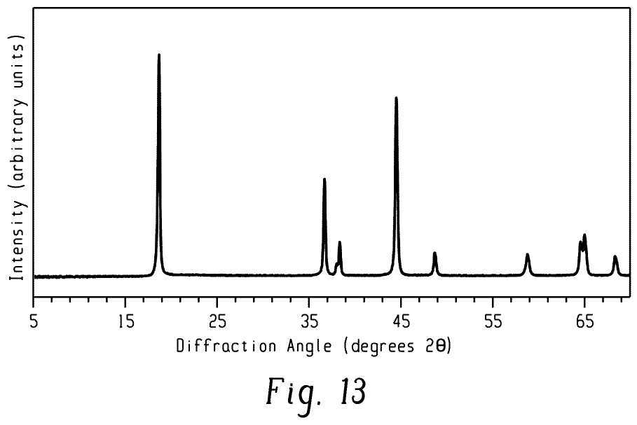

The product of Comparative Example 1 was calcined as set forth in Example 6. Particle size distribution in shown in FIG. 12. The D50 was 12.43 mm; the D90 was 20.47 mm. An XRD of the product is shown in FIG. 13.

### Example 8: Electrochemical Evaluation of the Product of Example 7

Cathode active material from Example 7 was mixed with conductive carbon (LITX™ HP from Cabot Corporation), and polyvinylidene fluoride (PVDF) binder (Kynar™ 500 from Arkema) at a weight ratio of 94:3:3 using N-methyl-2-pyrrolidone (NMP) as the solvent to make a slurry. A Thinky™ mixer was used for mixing. Firstly, PVDF binder and conductive carbon were mixed with NMP to provide a homogenous mixture. Then the cathode active material and additional NMP were added and mixed until a desirable viscosity (2000 to 5000 centipoise (cP)) was obtained. The final solids content was about 65 wt %, based on a total weight of mixture, to achieve a slurry having a honey-like consistency. Al foil was used as the current collector and a draw-down bar coater was used as the coating equipment for the slurry. The as-coated slurry was quick dried at 60° C. for 5 minutes and then at 120° C. for 5 minutes, then vacuum dried at 110° C. overnight. The cathode active material mass loading was targeted to be around 20 mg/cm². The final coating thickness was calendared to reach 30% of the targeted pressed porosity, resulting in a cathode having a coating thickness of 110 micrometers.

A 2032 type coin cell was used for electrochemical evaluation using the cathode, Li metal as the anode, and an electrolyte of 1.2 M LiPF₆ in EC:EMC (3:7) with 2 wt % VC, based on a total weight of the LiPF₆, EC, and EMC. Upon assembly, each cell was given 6 hours resting period prior to the formation cycle. The formation cycle contains C/10 charge to 4.3 V with a constant voltage (CV) hold at 4.3 V until current density decreased to C/20, follow by C/10 discharge to 2.8 V with 10 mins resting period. After 3 formation cycles, the cells were put to C/3 charge and discharge cycle for 100 cycles. Charge and discharge rates were determined based on the weight of the cathode active material and assuming 230 mAh/g.

This disclosure further encompasses the following aspects.

Aspect 1. A method of making a single-crystal cathode active material, the method comprising: providing a metal salt solution comprising nickel, cobalt, manganese, aluminum, or a combination thereof; combining the metal salt solution with a basic solution wherein the combination of the metal salt solution and the basic solution is maintained at a pH of no greater than 10 to form a metal hydroxide precursor; adding a lithium compound to the metal hydroxide precursor to form a metal hydroxide precursor mixture; and heat-treating the mixture to form the single-crystal cathode active material.

Aspect 2. The method of Aspect 1, wherein the pH is at least 7, preferably at least 8.

Aspect 3. The method of Aspect 1 or 2, wherein the metal salt solution is a metal sulfate solution in water, preferably an aqueous solution comprising NiSO₄·6H₂O, MnSO₄·H₂O, and CoSO₄·7H₂O.

Aspect 4. The method of any of the previous Aspects, wherein the basic solution comprises an alkali metal hydroxide, ammonium hydroxide or a combination thereof, preferably sodium hydroxide and ammonia, more preferably wherein the sodium hydroxide and ammonia are present in a ratio of 2:1 to 1:2, preferably 1.5:1 to 1:1.5, more preferably 1.2:1. to 1:1.

Aspect 5. The method of claim any of the previous Aspects, wherein the metal hydroxide precursor mixture is semicrystalline and comprises a beta phase (B) and an intermediate phase (I).

Aspect 6. The method of Aspect 5, wherein the beta phase has the formula M(OH)₂, wherein M comprises Ni, Mn, Co, Al, or a combination thereof, and the beta phase is characterized by a peak at 17 to 23 degrees 2θ, when analyzed by X-ray diffraction using Cu K_{α} radiation.

Aspect 7. The method of Aspect 5 or 6, wherein the intermediate phase has the formula M(OH)₂·yZ, wherein M comprises Ni, Mn, Co, Al, or a combination thereof, and wherein 0<y<0.75 and Z represents H₂O, a solvent, an anion, or a combination thereof, wherein the solvent is preferably ROH or RCOOH, wherein R is an alkyl group of 1 to 3 carbon atoms, or Z is preferably OH⁻, SO₄²⁻, NO₃⁻, CO₃²⁻, F⁻, Cl⁻, or a combination thereof, more preferably H₂O or SO₄²⁻, more preferably H₂O.

Aspect 8. The method of any of the previous Aspects, wherein the nickel, cobalt, manganese, aluminum, or a combination thereof comprises nickel, cobalt, and manganese in a molar ratio of Ni:Co:Mn of greater than 0 to 1:greater than 0 to 1:greater than 0 to 1, preferably 1:0.125:0.125, most preferably 1:0.18:0.18.

Aspect 9. The method of any of the previous Aspects, wherein the metal hydroxide precursor comprises at least 0.1 wt % to less than 3 wt % residual S content, preferably less than 2.5 wt %, more preferably less than 2 wt %, each based on total weight of the metal hydroxide precursor.

Aspect 10. The method of any of the previous Aspects, wherein the lithium compound comprises lithium hydroxide, lithium carbonate, lithium oxide, lithium oxalate, or a combination thereof.

Aspect 11. The method of any of the previous Aspects, wherein the heat-treating comprises heat-treating at a temperature of 600 to 1100° C. for 2 to 24 hours, preferably 800 to 1000° C., and more preferably 850 to 950° C.

Aspect 12. The method of any of the previous Aspects, wherein there is only one heat-treating step.

Aspect 13. The method of any of the previous Aspects, wherein a mole ratio of the lithium compound to the metal hydroxide precursor is 1 to 1.2, preferably 1.02 to 1.15, more preferably 1.05 to 1.10.

Aspect 14. The method of any one of the previous Aspects, wherein the cathode active material has the formula LiₓMO₂, wherein M is Ni, Co, Mn, Al, or a combination thereof, and 0<x≤1.2.

Aspect 15. The method of Aspect 14, wherein the cathode active material has the formula LiₓNi_{y}Co_{z}Mn_{y}O₂, wherein 0<x≤1.2 and 0.8≤(y+z+v)≤1.1, preferably, wherein y is 0.1 to 1, z is 0.01 to 0.1, and v is 0.01 to 0.1, more preferably having the formula LiNi_{0.88}Co_{0.06}Mn_{0.06}O₂.

Aspect 16. The method of any of the previous Aspects, wherein the cathode active material formed during the heat-treating comprises monodispersed single crystals with a unimodal particle size distribution.

Aspect 17. The method of any of the previous Aspects, wherein the cathode active material comprises single crystals having a D50 particle size as determined according to ASTM C115 of greater than 100 nm and less than 10 μm, preferably 1 to 5 μm, more preferably 1 to 3 μm.

Aspect 18. The method of any of the previous Aspects, wherein the cathode active material comprises single crystals having a D90 particle size as determined according to ASTM C115 of greater than 1 μm and less than 20 μm, preferably 3 to 10 μm, more preferably 5 to 8 μm.

Aspect 19. The method of any of the previous Aspects, further comprising washing the cathode active material after the heat-treating.

Aspect 20. The method of any of the previous Aspects, wherein the cathode active material comprises less than 10, preferably less than 7 wt %, based on total weight of cathode active material, of residual lithium hydroxide, lithium carbonate, lithium oxide, lithium oxalate, lithium sulfate, or a combination thereof on the surface of the cathode active material.

Aspect 21. The method of any of the previous Aspects, wherein the cathode active material is characterized by an average discharge capacity of greater than 200 mAh/g at a discharge rate of C/3 for a half-cell over 100 cycles.

Aspect 22. The method of any of the previous Aspects, wherein the metal salt solution comprises a metal obtained from a recycled feedstock, preferably a post-industrial recycled feedstock, a post-consumer recycled feedstock, or a combination thereof.

Aspect 23. The method of any of the previous Aspects, wherein the mixture subjected to the heat-treating step comprises 0.1 to 5 wt % lithium carbonate.

Aspect 24. A method of making a monodispersed single crystal cathode active material, the method comprising providing a metal hydroxide precursor comprising nickel, cobalt, manganese, aluminum, or a combination thereof, wherein the metal hydroxide precursor is characterized as semicrystalline and comprises a beta phase characterized by a peak at 17 to 23 degrees 2θ, when analyzed by X-ray diffraction using Cu K_{α} radiation, and
an intermediate phase characterized by having H₂O, ROH, RCOOH, an anion, or a combination thereof incorporated into a structure of the intermediate phase, wherein R is an alkyl group of 1 to 3 carbon atoms; adding a lithium compound to the metal hydroxide precursor to form a mixture, and heating the mixture in a one-step calcination to form the monodispersed single crystal cathode active material, the single crystal cathode active material having a unimodal particle size distribution and a D50 particle size distribution of 100 nm to 5 μm or a D90 particle size distribution of 1 to 10 μm.

Aspect 25. The method of Aspect 24. wherein the anion comprises OH⁻, SO₄²⁻, NO₃⁻, CO₃²⁻, F⁻, Cl⁻, or a combination thereof.

Aspect 26. The method of Aspect 24, wherein water, sulfate ions, or both are incorporated into the structure of the intermediate phase.

Aspect 27. The method of any one of Aspects 24-26, wherein the beta phase has the formula M(OH)₂, wherein M is Ni, Co, Mn, Al, or a combination thereof.

Aspect 28. The method of any one of Aspects 24-27, wherein the nickel, cobalt, manganese, aluminum, or a combination thereof comprises nickel, cobalt, and manganese, and a molar ratio of Ni:Co:Mn is greater than 0 to 1:greater than 0 to 1:greater than 0 to 1, preferably 1:0.125:0.125, most preferably 1:0.18:0.18. (90/5/5).

Aspect 29. The method of any one of Aspects 24-28, wherein the lithium compound comprises lithium hydroxide, lithium carbonate, lithium oxide, lithium oxalate, or a combination thereof.

Aspect 30. The method of any one of Aspects 24-29, wherein the heat-treating comprises heating at a temperature of 600 to 1100° C. for 2 to 24 hours, preferably 800 to 1000° C., or more preferably 850 to 950° C.

Aspect 31. The method of any one of Aspects 24-30, wherein the mole ratio of the lithium compound to the metal hydroxide precursor is 1 to 1.2, preferably 1.02 to 1.15, more preferably 1.05 to 1.10.

Aspect 32. The method of any one of Aspects 24-31, wherein the cathode active material has the formula LiₓMO₂, wherein M is Ni, Co, Mn, Al, or a combination thereof, and 0<x≤1.2.

Aspect 33. The method of Aspect 32, wherein the cathode active material has the formula LiₓNi_{y}Co_{z}MnᵥO₂, wherein 0<x≤1.2 and 0.8≤(y+z+v)≤1.1, preferably, wherein y is 0.1 to 1, z is 0.01 to 0.1, and v is 0.01 to 0.1, more preferably having the formula LiNi_{0.88}Co_{0.06}Mn_{0.06}O₂.

Aspect 34. The method of any one of Aspects 24-33, further comprising washing the cathode active material after the heat-treating.

Aspect 35. The method of any one of Aspects 24-34, wherein the cathode active material comprises less than 10 wt %, based on total weight of cathode active material, of residual lithium hydroxide, lithium carbonate, lithium oxide, lithium oxalate, lithium sulfate or a combination thereof on the surface of the cathode active material.

Aspect 36. The method of any one of Aspects 24-35, wherein the cathode active material is characterized by an average discharge capacity of greater than 200 mAh/g at a discharge rate of C/3 for a half-cell over 100 cycles.

Aspect 37. The method of any one of Aspects 24-36, wherein the mixture subjected to the heat-treating comprises 0.1 to 5 wt % lithium carbonate.

Aspect 38. A metal hydroxide composition comprising: a metal hydroxide comprising nickel, cobalt, manganese, aluminum, or a combination thereof, wherein the metal hydroxide is characterized as semicrystalline and comprises a beta phase characterized by a peak at 17 to 23 degrees 2θ, when analyzed by X-ray diffraction using Cu K_{α} radiation, and having a formula M(OH)₂, wherein M is Ni, Co, Mn, Al, or a combination thereof, and
an intermediate phase characterized by having H₂O, ROH, RCOOH, an anion, or a combination thereof incorporated into the structure of the intermediate phase, wherein R is an alkyl group of 1 to 3 carbon atoms.

Aspect 39. The metal hydroxide composition of Aspect 38, wherein water, sulfate ions, or both are incorporated into the structure of the intermediate phase.

Aspect 40. A single crystal cathode active material having the formula LiₓMO₂, wherein M is Ni, Co, Mn, Al, or a combination thereof, and 0<x≤1.2, characterized by a unimodal particle size distribution of monodispersed single crystals having a D50 particle size distribution of 100 nm to 5 μm or a D90 particle size of 1 to 10 μm, and the presence of Li₂SO₄.

Aspect 41. The single crystal active material of Aspect 40, wherein the presence of Li₂SO₄ is determined by peaks at 22 to 29 degrees 2θ, when analyzed by X-ray diffraction using Cu K_{α} radiation.

Aspect 42: The single crystal active material of Aspect 40 or 42 made by the method of any one of Aspects 1-37.

Aspect 43: The metal hydroxide composition of Aspect 38 or 39 made by a method comprising: providing a metal salt solution comprising nickel, cobalt, manganese, aluminum, or a combination thereof; combining the metal salt solution with a basic solution wherein the combination of the metal salt solution and the basic solution is maintained at a pH of no greater than 10, and preferably at least 7, more preferably at least 8, to form a metal hydroxide precursor.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). Moreover, stated upper and lower limits can be combined to form ranges (e.g., “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”). “Or” means “and/or” unless specifically stated otherwise.

The disclosure may alternately comprise, consist of, or consist essentially of, any appropriate components herein disclosed. The disclosure may additionally, or alternatively, be formulated so as to be devoid, or substantially free, of any components, materials, ingredients, adjuvants or species used in the prior art compositions or that are otherwise not necessary to the achievement of the function and/or objectives of the present disclosure.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

Unless specified to the contrary herein, all test standards are the most recent standard in effect as of the filing date of this application, or, if priority is claimed, the filing date of the earliest priority application in which the test standard appears.

1. A method of making a single-crystal cathode active material, the method comprising:
providing a metal salt solution comprising nickel, cobalt, manganese, aluminum, or a combination thereof;
combining the metal salt solution with a basic solution wherein the combination of the metal salt solution and the basic solution is maintained at a pH of no greater than 10 to form a metal hydroxide precursor;
adding a lithium compound to the metal hydroxide precursor to form a metal hydroxide precursor mixture; and
heat-treating the metal hydroxide precursor mixture to form the single-crystal cathode active material.

2. The method of claim 1, wherein the pH is at least 7.

3. The method of claim 1, wherein
the metal salt solution is a metal sulfate solution in water; and
the basic solution comprises an alkali metal hydroxide, ammonium hydroxide or a combination.

4. The method of claim 1, wherein the metal hydroxide precursor mixture is semicrystalline and comprises a beta phase (B) and an intermediate phase (I).

5. The method of claim 4, wherein
the beta phase has the formula M(OH)₂, wherein M comprises Ni, Mn, Co, Al, or a combination thereof, and the beta phase is characterized by a peak at 17 to 23 degrees 2θ, when analyzed by X-ray diffraction using Cu K_{α} radiation; and
the intermediate phase has the formula M(OH)₂·yZ, wherein M comprises Ni, Mn, Co, Al, or a combination thereof, and wherein 0<y<0.75 and Z represents H₂O, a solvent, an anion, or a combination thereof.

6. The method of claim 1, wherein the nickel, cobalt, manganese, aluminum, or a combination thereof comprises nickel, cobalt, and manganese in a molar ratio of Ni:Co:Mn of greater than 0 to 1:greater than 0 to 1:greater than 0 to 1.

7. The method of claim 1, wherein the metal hydroxide precursor comprises at least 0.1 wt % to less than 3 wt % residual S content, based on total weight of the metal hydroxide precursor.

8. The method of claim 1, wherein the lithium compound comprises lithium hydroxide, lithium carbonate, lithium oxide, lithium oxalate, or a combination thereof.

9. The method of claim 1, wherein the heat-treating comprises heat-treating at a temperature of 600 to 1100° C. for 2 to 24 hours.

10. The method of claim 1, wherein there is only one heat-treating step.

11. The method of claim 1, wherein a mole ratio of the lithium compound to the metal hydroxide precursor is 1 to 1.2.

12. The method of claim 1, wherein the cathode active material has the formula LiₓMO₂, wherein M is Ni, Co, Mn, Al, or a combination thereof, and 0<x≤1.2.

13. The method of claim 12, wherein the cathode active material has the formula LiₓNi_{y}Co_{z}MnᵥO₂, wherein 0<x≤1.2 and 0.8≤(y+z+v)≤1.1.

14. The method of claim 1, wherein the cathode active material formed during the heat-treating comprises monodispersed single crystals with a unimodal particle size distribution.

15. The method of claim 1, wherein the cathode active material comprises single crystals having
a D50 particle size as determined according to ASTM C115 of greater than 100 nm and less than 10 μm; and
a D90 particle size as determined according to ASTM C115 of greater than 1 μm and less than 20 μm.

16. The method of claim 1, wherein the cathode active material comprises less than 10 wt % based on total weight of cathode active material, of residual lithium hydroxide, lithium carbonate, lithium oxide, lithium oxalate, lithium sulfate, or a combination thereof on the surface of the cathode active material.

17. The method of claim 1, wherein the cathode active material is characterized by an average discharge capacity of greater than 200 mAh/g at a discharge rate of C/3 for a half-cell over 100 cycles.

18. The method of claim 1, wherein the metal salt solution comprises a metal obtained from a recycled feedstock.

19. The method of claim 1, wherein the mixture subjected to the heat-treating step comprises 0.1 to 5 wt % lithium carbonate.

20. A method of making a monodispersed single-crystal cathode active material, the method comprising
providing a metal hydroxide precursor comprising nickel, cobalt, manganese, aluminum, or a combination thereof,
wherein the metal hydroxide precursor is characterized as semicrystalline and comprises
a beta phase characterized by a peak at 17 to 23 degrees 2θ, when analyzed by X-ray diffraction using Cu K_{α} radiation, and
an intermediate phase characterized by having H₂O, ROH, RCOOH, an anion comprising OH⁻, SO₄²⁻, NO₃⁻, CO₃²⁻, F⁻, Cl⁻, or a combination thereof, or a combination thereof incorporated into a structure of the intermediate phase;
adding a lithium compound to the metal hydroxide precursor to form a mixture; and
heating the mixture in a one-step calcination to form the monodispersed single crystal cathode active material, the monodispersed single crystal cathode active material having a unimodal particle size distribution and a D50 particle size distribution of 100 nm to 5 μm, a D90 particle size distribution of 1 to 10 μm, or both.

21. The method of claim 20, wherein the beta phase has the formula M(OH)₂, wherein M is Ni, Co, Mn, Al, or a combination thereof.

22. The method of claim 20, wherein the nickel, cobalt, manganese, aluminum, or a combination thereof comprises nickel, cobalt, and manganese, and a molar ratio of Ni:Co:Mn is greater than 0 to 1:greater than 0 to 1:greater than 0 to 1.

23. The method of claim 20, wherein the lithium compound comprises lithium hydroxide, lithium carbonate, lithium oxide, lithium oxalate, or a combination thereof.

24. The method of claim 20, wherein the heat-treating comprises heating at a temperature of 600 to 1100° C. for 2 to 24 hours.

25. The method of claim 20, wherein the mole ratio of the lithium compound to the metal hydroxide precursor is 1 to 1.2.

26. The method of claim 20, wherein the cathode active material has the formula LiₓMO₂, wherein M is Ni, Co, Mn, Al, or a combination thereof, and 0<x≤1.2.

27. The method of claim 20, wherein the cathode active material comprises less than 10 wt %, based on total weight of cathode active material, of residual lithium hydroxide, lithium carbonate, lithium oxide, lithium oxalate, lithium sulfate or a combination thereof on the surface of the cathode active material.

28. The method of claim 20, wherein the cathode active material is characterized by an average discharge capacity of greater than 200 mAh/g at a discharge rate of C/3 for a half-cell over 100 cycles.

29. The method of claim 20, wherein the mixture subjected to the heat-treating comprises 0.1 to 5 wt % lithium carbonate.

30. A metal hydroxide composition comprising:
a metal hydroxide comprising nickel, cobalt, manganese, aluminum, or a combination thereof, wherein the metal hydroxide is semicrystalline and comprises
a beta phase characterized by a peak at 17 to 23 degrees 2θ, when analyzed by X-ray diffraction using Cu K_{α} radiation, and having a formula M(OH)₂, wherein M is Ni, Co, Mn, Al, or a combination thereof, and
an intermediate phase characterized by having H₂O, ROH, RCOOH, an anion, or a combination thereof incorporated into the structure of the intermediate phase, wherein R is an alkyl group of 1 to 3 carbon.

31. A single crystal cathode active material having the formula LiₓMO₂, wherein M is Ni, Co, Mn, Al, or a combination thereof, and 0<x≤1.2, characterized by
a unimodal particle size distribution of monodispersed single crystals having a D50 particle size distribution of 100 nm to 5 μm, a D90 particle size of 1 to 10 μm, or both, and
the presence of Li₂SO₄.
